(19) United States
(12) Patent Application Publication
(10) Pub. No.: US 2026/0324740 A1
(43) Pub. Date: Oct. 22, 2026

(54) AEROSOL GENERATING APPARATUS

(71) Applicant: Imperial Tobacco Limited, Bristol, Avon (GB)

(72) Inventors: Andrew Robert Wallace, Bristol, Avon (GB); Joshua John Arthur Dryden, Bristol, Avon (GB)

(21) Appl. No.: 19/104,618

(22) PCT Filed: Aug. 24, 2023
(86) PCT No.: PCT/EP2023/073307

§ 371 Date: Feb. 18, 2025

(30) Foreign Application Priority Data
Aug. 31, 2022 (EP) 22193273.4

(51) Int. Cl. A24F 40/50; A24F 40/70; H05B 3/06

(52) U.S. Cl. CPC A24F 40/50; A24F 40/70; H05B 3/06

(57) ABSTRACT

The disclosure provides an aerosol generating device (1), the aerosol generating device lbeing elongate and having a longitudinal axis and a transverse axis perpendicular to the longitudinal axis. The aerosol generating device (1) comprises an external housing (510), and further includes an internal frame (510) defining a chamber for receiving a power source (4) of the aerosol generating device (1), the internal frame (520) being located within the external housing (510). The aerosol generating device (1) further comprises a printed circuit board (540) (PCB). The internal frame (520) includes a window (530), and the external housing (510) and the window (520) define a PCB cavity for receiving a portion of the PCB (540). The disclosure further provides an internal frame for use in an aerosol generating device (1), and a method of assembling an aerosol generating device (1).

### This application claims priority from EP 22193273.4 filed 31 Aug. 2022, the contents and elements of which are herein incorporated by reference for all purposes.

### FIELD

The present disclosure relates to an aerosol generating apparatus.

### BACKGROUND

A typical aerosol generating apparatus may comprise a power supply, an aerosol generating unit that is driven by the power supply, an aerosol precursor, which in use is aerosolised by the aerosol generating unit to generate an aerosol, and a delivery system for delivery of the aerosol to a user.

A drawback with known aerosol generating apparatuses is achieving suitable placement of the internal components within the device, for example by providing suitable spaces for each of the components.

In spite of the effort already invested in the development of aerosol generating apparatuses/systems further improvements are desirable.

### SUMMARY

According to a first aspect of the present disclosure, there is provided an aerosol generating device, the aerosol generating device being elongate and having a longitudinal axis and a transverse axis perpendicular to the longitudinal axis. The aerosol generating device comprises an external housing, an internal frame, and a printed circuit board (PCB). The internal frame defines a chamber for receiving a power source of the aerosol generating device, and is located within the external housing. The internal frame includes a window, and the external housing and the window define a PCB cavity for receiving a portion of the PCB.

The provision of an internal frame or chassis provides an internal supporting structure for the aerosol generating device. For example, it may provide a frame in or to which the internal components of the aerosol generating device may be mounted during assembly of the device, resulting in a single assembly that can be inserted into the external housing. In some cases, this may result in reduced movement, such as rattling, of internal components of the device for improved device durability and usability.

The provision of a window in the internal frame and a PCB cavity may enable an improved distribution of components within the aerosol generating device. For example, it may enable increased space within the chamber, allowing for a larger power source to be used in the aerosol generating device. Providing a cavity for receiving a part of the PCB may also enable the PCB to be more securely mounted to the internal frame, which can further improve device durability.

In some examples, the PCB may comprise a substrate and an electronic component for controlling an operation of the aerosol generating device. The electronic component may be mounted on a surface of the substrate. Examples of electronic components that may be mounted on a surface of the substrate may include components such as an interconnect, a resistor, a capacitor, a transistor, an integrated circuit, a memory device, and a switch. In still further examples, the electronic component may be located at least partially within the PCB cavity. This may, for example, provide a space around the component for heat dissipation and/or for impact protection. Furthermore, where the electronic components are mounted on only one surface of the substrate, a reverse side of the substrate may present a smooth and uniform surface with no projecting elements towards the chamber. This may increase ease of locating the power source within the chamber adjacent to the PCB. In some examples, the substrate is generally flat.

In some examples, the aerosol generating device further comprises a power source received in the chamber. In some examples, the power source may be a battery. The battery may be a rechargeable battery, or may be a non-rechargeable battery. Where the battery is a rechargeable battery, the battery may be permanently mounted in the aerosol generating device, and the aerosol generating device may also include charging circuitry and a connection point for connecting the aerosol generating device to a source of electricity.

In some examples, the internal frame may have an arcuate external profile in a transverse plane perpendicular to the longitudinal axis. In other words, when viewing the internal frame looking along the longitudinal axis of the aerosol generating device, the bounding surface of the outer extent of the volume occupied by the frame may have a curved or actuate shape. An arcuate external profile of the internal frame may thereby create the space or cavity for receiving the PCB. For example, the power source and associated chamber may be approximately cuboidal, wherein the arcuate profile of the internal frame creates an additional volume around the chamber for receiving the PCB.

In some examples the external housing may have an internal profile in the transverse plane commensurate with the external profile of the internal frame in the transverse plane. Commensurate in this sense means corresponding in size and or extent. In other words, the external housing has an interior space having a shape that closely or snugly surrounds the internal frame. In this way, the space within the internal frame for the power source and the PCB is maximised. Furthermore, a tight, close, or snug fit between the internal frame and the external housing may ensure that the internal frame is more stably mounted within the external housing for reduced vibration between internal components of the aerosol generating device.

In some examples, the external profile of the internal frame is substantially constant along at least part of an extent of the internal frame along the longitudinal axis of the aerosol generating device. In other examples, the external profile may taper from one end of the aerosol generating device. In this way, the internal frame may be slidable into the external housing, providing increased ease of assembly for the aerosol generating device.

In some examples, the internal frame may comprise a plurality of windows and at least one separation rib may be located between adjacent windows. Providing a plurality of windows separated by a separation rib may ensure that the internal frame has increased structural rigidity.

In some examples, the windows may be arranged longitudinally along the aerosol generating device.

In some examples, the internal frame may comprise two longitudinally extending struts. The separation rib may span between the two struts. The separation rib therefore may act as a brace between the two longitudinally extending struts to provide increased structural rigidity of the internal frame.

In some examples, the separation rib may span a portion of the PCB. The separation rib may thus provide impact protection to the PCB during device assembly and/or device usage.

In some examples, the external housing and a first window of the plurality of windows may define a first PCB cavity. The external housing and a second window of the plurality of windows may define a second PCB cavity. A first portion of the PCB may be received in the first PCB cavity and a second portion of the PCB may be received in the second PCB cavity. Providing multiple windows in this way may ensure a balance between providing a PCB cavity of sufficient dimension to contain the PCB and ensuring structural integrity of the internal frame. It may also ensure more stable positioning of the PCB within the aerosol generating device by reducing a freedom of movement of the PCB and/or providing more attachment points for the PCB to the internal frame. It may improve manufacturing efficiency by reducing variability in PCB positioning when assembling the device.

In some examples, the PCB may include a first PCB and a second PCB. The first PCB may be received in the first PCB cavity and the second PCB may be received in the second PCB cavity. Provision of more than one PCB may enable, for example, increased ease of handling of components and/or improved manufacture by dividing electronic components between more than one PCB for inclusion in the aerosol generating device.

In some examples, the internal frame includes a first internal frame component and a second internal frame component. Providing an internal frame formed of more than one component may increase ease of manufacture for the frame. For example, it may enable increased ease of moulding or machining of the frame and/or reduced material wastage by enabling each component to be manufactured separately.

In some example, the first internal frame component and the second internal frame component may be elongate along the longitudinal axis. The first internal frame component may define a first part of the external profile of the internal frame in a transverse plane perpendicular to the longitudinal axis. The second internal frame component may define a second part of the external profile of the internal frame in the transverse plane perpendicular to the longitudinal axis. In other words, each of the first and second internal frame components may extend at least part way along a length of the aerosol generating device. One internal frame component may then form one side of the frame, while another frame component may form the other side of the frame. For example, when the aerosol generating device has a particular orientation for usage, such that it has a front, a back, a left side and a right side, one internal frame component may form a front portion of the frame within the aerosol generating device, while the second forms a rear portion of the frame within the aerosol generating device. In other examples, one internal frame component may form a left-side portion of the frame within the aerosol generating device, while the second forms a right-side portion of the frame within the aerosol generating device. The two frame components may be arranged in other relative arrangements as required for assembly of the internal frame of the aerosol generating device.

In some examples, the internal frame may further include an interface between the first internal frame component and the second internal frame component along which the first and second internal frame components are in mutual contact, the interface extending along the longitudinal axis of the aerosol generating device. This interface or joint may be a line or face along which the first and second internal frame components are in contact with each other, and/or may be a line or face at which the first and second internal frame components are attached to each other. For example, the first and second internal frame components may be attached together at the interface via an adhesive or glue, via an attaching component including a screw or rivet, via a snap-fit connection or via a combination of the above. Still further attachment mechanisms or components may be utilised as required.

In some examples, the first internal frame component may comprise two longitudinally extending struts and a separation rib. The first internal frame component may thereby form or include a window of the internal frame. Providing a window to be defined by a single component may reduce the potential for manufacturing errors or excessive tolerance requirements by ensuring consistency in the frame assembly.

In some examples, the external housing may be fixed to the internal frame via a fixing component. The fixing component may include a screw. The fixing component may include a pin which may be spring-loaded, and may further include a corresponding socket for the pin to engage with. The fixing component may include projections or latches to form a snap fit connection. A fixing component for fixing the internal frame to the external housing may improve assembly of the device by enabling the internal frame and external housing to be positioned relative to each other and joined or fixed together in a particular arrangement.

In some examples, the aerosol generating device may include a cap for engaging with a consumable for the aerosol generating device. The cap may be slidably mounted to the internal frame to be slidable along a longitudinal axis of the aerosol generating device. The internal frame may thus act as a chassis structure to which the movable component (the cap) may be mounted. In some examples, the aerosol generating device may further include a heating element mounted to the internal frame. The cap may slidable between a first position wherein the heating element is enclosed within the cap and a second position wherein the heating element is at least partially exposed in a gap between the cap and the external housing. In this way, the heating element may be protected from damage in normal usage. Furthermore, a possibility for accidental user contact with the heating element may be reduced. Meanwhile, exposing the heating element may enable increased ease of maintenance and/or cleaning of the heating element, for example to remove foreign matter from the heating element.

In some examples, the external housing is opaque. For example, where the aerosol generating device does not include any components such as display elements that require to be visible through the external housing, an opaque external housing may suitably obscure the internal components.

In some examples, the internal frame may be formed of an electrically insulating material. In this way, should the PCB contact the internal frame incorrectly, a risk of a short-circuit through the frame is reduced. This may also protect the PCB from, for example, faults with a charging system and/or heater element by reducing electrical contact between different elements of the aerosol generating device.

According to a second aspect of the present disclosure, there is provided an internal frame for use in an aerosol generating device of the first aspect.

The present disclosure may also provide a method of manufacturing an aerosol generating device, which may implement any one or more features disclosed herein. The method may comprise the steps of providing an internal frame according to the second aspect of the present disclosure; mounting a power source in the chamber; mounting a PCB in the window; providing an external housing; and sliding the internal frame into the external housing.

The manufacturing process may further comprise a step of providing and mounting a cap to the internal frame before providing an internal housing. This therefore provides a single subassembly that can be slid into an external housing to complete assembly of the device for more efficient manufacture.

The preceding summary is provided for purposes of summarizing some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE FIGURES

Aspects, features and advantages of the present disclosure will become apparent from the following description of examples in reference to the appended drawings in which like numerals denote like elements.

FIG. 1 is a block system diagram showing an example aerosol generating apparatus.

FIG. 2 is a block system diagram showing an example implementation of the apparatus of FIG. 1, where the aerosol generating apparatus is configured to generate aerosol from a liquid precursor.

FIGS. 3a and 3b are schematic diagrams showing an example implementation of the apparatus of FIG. 2.

FIG. 4 is a block system diagram showing an example implementation of the apparatus of FIG. 1, where the aerosol generating apparatus is configured to generate aerosol from a solid precursor.

FIG. 5 is a schematic diagram showing an example implementation of the apparatus of FIG. 4.

FIG. 6 is a schematic diagram showing an internal frame of an aerosol generating device.

FIG. 7 is a schematic diagram showing an internal frame assembly of an aerosol generating device.

FIG. 8 is a cross-sectional schematic diagram showing an internal frame of an aerosol generating device.

FIG. 9 is a cross-sectional schematic diagram showing an internal frame of an aerosol generating device.

FIG. 10 is a schematic diagram showing a front portion of an internal frame of an aerosol generating device.

FIG. 11 is a schematic diagram showing a rear portion of an internal frame of an aerosol generating device.

FIG. 12 is a schematic diagram showing an exploded view of an internal frame of an aerosol generating device.

FIG. 13 is a schematic diagram showing an internal frame of an aerosol generating device.

FIG. 14 is a schematic diagram showing an internal frame and a cap of an aerosol generating device.

FIG. 15 is a schematic diagram showing an aerosol generating device with a cap in a first position.

FIG. 16 is a schematic diagram showing an aerosol generating device with a cap in a second position.

FIG. 17 is a schematic diagram showing an internal frame assembly of an aerosol generating device.

FIG. 18 is a schematic diagram showing an external housing of an aerosol generating device.

FIG. 19 is a flow diagram for an assembly process of an aerosol generating device.

### DETAILED DESCRIPTION OF EMBODIMENTS

Before describing several examples implementing the present disclosure, it is to be understood that the present disclosure is not limited by specific construction details or process steps set forth in the following description and accompanying drawings. Rather, it will be apparent to those skilled in the art having the benefit of the present disclosure that the systems, apparatuses and/or methods described herein could be embodied differently and/or be practiced or carried out in various alternative ways.

Unless otherwise defined herein, scientific and technical terms used in connection with the presently disclosed inventive concept(s) shall have the meanings that are commonly understood by those of ordinary skill in the art, and known techniques and procedures may be performed according to conventional methods well known in the art and as described in various general and more specific references that may be cited and discussed in the present specification.

Any patents, published patent applications, and non-patent publications mentioned in the specification are hereby incorporated by reference in their entirety.

All examples implementing the present disclosure can be made and executed without undue experimentation in light of the present disclosure. While particular examples have been described, it will be apparent to those of skill in the art that variations may be applied to the systems, apparatus, and/or methods and in the steps or in the sequence of steps of the methods described herein without departing from the concept, spirit, and scope of the inventive concept(s). All such similar substitutions and modifications apparent to those skilled in the art are deemed to be within the spirit, scope, and concept of the inventive concept(s) as defined by the appended claims.

The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context.

The use of the term “or” in the present disclosure (including the claims) is used to mean an inclusive “and/or” unless explicitly indicated to refer to alternatives only or unless the alternatives are mutually exclusive. For example, a condition “A or B” is satisfied by any of the following: A is true (or present), and B is false (or not present), A is false (or not present), and B is true (or present), and both A and B are true (or present).

As used in this specification and claim(s), the words “comprising, “having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of example(s), embodiment(s), or dependency of claim(s). Moreover, this also applies to the phrase “in one embodiment,” “according to an embodiment,” and the like, which are merely a stylistic form of wording and are not to be construed as limiting the following features to a separate embodiment to all other instances of the same or similar wording. This is to say, a reference to ‘an,’ ‘one,’ or ‘some’ embodiment(s) may be a reference to any one or more, and/or all embodiments, or combination(s) thereof, disclosed. Also, similarly, the reference to “the” embodiment may not be limited to the immediately preceding embodiment. Further, all references to one or more embodiments or examples are to be construed as non-limiting to the claims.

The present disclosure may be better understood in view of the following explanations, wherein the terms used that are separated by “or” may be used interchangeably:

As used herein, an “aerosol generating apparatus” (or “electronic(e)-cigarette”) may be an apparatus configured to deliver an aerosol to a user for inhalation by the user. The apparatus may additionally/alternatively be referred to as a “smoking substitute apparatus”, if it is intended to be used instead of a conventional combustible smoking article. As used herein a combustible “smoking article” may refer to a cigarette, cigar, pipe, or other article, that produces smoke (an aerosol comprising solid particulates and gas) via heating above the thermal decomposition temperature (typically by combustion and/or pyrolysis). An aerosol generated by the apparatus may comprise an aerosol with particle sizes of 0.2-7 microns, or less than 10 microns, or less than 7 microns. This particle size may be achieved by control of one or more of: heater temperature; cooling rate as the vapour condenses to an aerosol; flow properties including turbulence and velocity. The generation of aerosol by the aerosol generating apparatus may be controlled by an input device. The input device may be configured to be user-activated, and may for example include or take the form of an actuator (e.g. actuation button) and/or an airflow sensor.

Each occurrence of the aerosol generating apparatus being caused to generate aerosol for a period of time (which may be variable) may be referred to as an “activation” of the aerosol generating apparatus. The aerosol generating apparatus may be arranged to allow an amount of aerosol delivered to a user to be varied per activation (as opposed to delivering a fixed dose of aerosol), e.g. by activating an aerosol generating unit of the apparatus for a variable amount of time, e.g. based on the strength/duration of a draw of a user through a flow path of the apparatus (to replicate an effect of smoking a conventional combustible smoking article).

The aerosol generating apparatus may be portable. As used herein, the term “portable” may refer to the apparatus being for use when held by a user.

As used herein, an “aerosol generating system” may be a system that includes an aerosol generating apparatus and optionally other circuitry/components associated with the function of the apparatus, e.g. one or more external devices and/or one or more external components (here “external” is intended to mean external to the aerosol generating apparatus). As used herein, an “external device” and “external component” may include one or more of a: a charging device, a mobile device (which may be connected to the aerosol generating apparatus, e.g. via a wireless or wired connection); a networked-based computer (e.g. a remote server); a cloud-based computer; any other server system.

An example aerosol generating system may be a system for managing an aerosol generating apparatus. Such a system may include, for example, a mobile device, a network server, as well as the aerosol generating apparatus.

As used herein, an “aerosol” may include a suspension of precursor, including as one or more of: solid particles; liquid droplets; gas. Said suspension may be in a gas including air. An aerosol herein may generally refer to/include a vapour. An aerosol may include one or more components of the precursor.

As used herein, a “precursor” may include one or more of a: liquid; solid; gel; loose leaf material; other substance. The precursor may be processed by an aerosol generating unit of an aerosol generating apparatus to generate an aerosol. The precursor may include one or more of: an active component; a carrier; a flavouring. The active component may include one or more of nicotine; caffeine; a cannabidiol oil; a non-pharmaceutical formulation, e.g. a formulation which is not for treatment of a disease or physiological malfunction of the human body. The active component may be carried by the carrier, which may be a liquid, including propylene glycol and/or glycerine. The term “flavouring” may refer to a component that provides a taste and/or a smell to the user. The flavouring may include one or more of: Ethylvanillin (vanilla); menthol, Isoamyl acetate (banana oil); or other. The precursor may include a substrate, e.g. reconstituted tobacco to carry one or more of the active component; a carrier; a flavouring.

As used herein, a “storage portion” may be a portion of the apparatus adapted to store the precursor. It may be implemented as fluid-holding reservoir or carrier for solid material depending on the implementation of the precursor as defined above.

As used herein, a “flow path” may refer to a path or enclosed passageway through an aerosol generating apparatus, e.g. for delivery of an aerosol to a user. The flow path may be arranged to receive aerosol from an aerosol generating unit. When referring to the flow path, upstream and downstream may be defined in respect of a direction of flow in the flow path, e.g. with an outlet being downstream of an inlet.

As used herein, a “delivery system” may be a system operative to deliver an aerosol to a user. The delivery system may include a mouthpiece and a flow path.

As used herein, a “flow” may refer to a flow in a flow path. A flow may include aerosol generated from the precursor. The flow may include air, which may be induced into the flow path via a puff by a user.

As used herein, a “puff” (or “inhale” or “draw”) by a user may refer to expansion of lungs and/or oral cavity of a user to create a pressure reduction that induces flow through the flow path.

As used herein, an “aerosol generating unit” may refer to a device configured to generate an aerosol from a precursor. The aerosol generating unit may include a unit to generate a vapour directly from the precursor (e.g. a heating system or other system) or an aerosol directly from the precursor (e.g. an atomiser including an ultrasonic system, a flow expansion system operative to carry droplets of the precursor in the flow without using electrical energy or other system). A plurality of aerosol generating units to generate a plurality of aerosols (for example, from a plurality of different aerosol precursors) may be present in an aerosol generating apparatus.

As used herein, a “heating system” may refer to an arrangement of at least one heating element, which is operable to aerosolise a precursor once heated. The at least one heating element may be electrically resistive to produce heat from the flow of electrical current therethrough. The at least one heating element may be arranged as a susceptor to produce heat when penetrated by an alternating magnetic field. The heating system may be configured to heat a precursor to below 300 or 350 degrees C, including without combustion.

As used herein, a “consumable” may refer to a unit that includes a precursor. The consumable may include an aerosol generating unit, e.g. it may be arranged as a cartomizer. The consumable may include a mouthpiece. The consumable may include an information carrying medium. With liquid or gel implementations of the precursor, e.g. an e-liquid, the consumable may be referred to as a “capsule” or a “pod” or an “e-liquid consumable”. The capsule/pod may include a storage portion, e.g. a reservoir or tank, for storage of the precursor. With solid material implementations of the precursor, e.g. tobacco or reconstituted tobacco formulation, the consumable may be referred to as a “stick” or “package” or “heat-not-burn consumable”. In a heat-not-burn consumable, the mouthpiece may be implemented as a filter and the consumable may be arranged to carry the precursor. The consumable may be implemented as a dosage or pre-portioned amount of material, including a loose-leaf product.

As used herein, an “information carrying medium” may include one or more arrangements for storage of information on any suitable medium. Examples include: a computer readable medium; a Radio Frequency Identification (RFID) transponder; codes encoding information, such as optical (e.g. a bar code or QR code) or mechanically read codes (e.g. a configuration of the absence or presents of cut-outs to encode a bit, through which pins or a reader may be inserted).

As used herein “heat-not-burn” (or “HNB” or “heated precursor”) may refer to the heating of a precursor, typically tobacco, without combustion, or without substantial combustion (i.e. localised combustion may be experienced of limited portions of the precursor, including of less than 5% of the total volume).

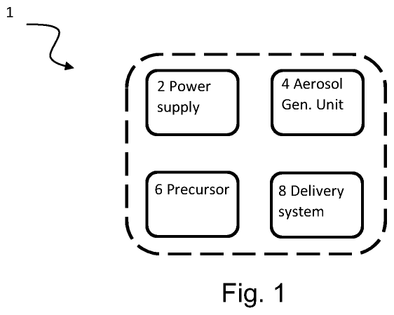

Referring to FIG. 1, an example aerosol generating apparatus 1 includes a power supply 2, for supply of electrical energy. The apparatus 1 includes an aerosol generating unit 4 that is driven by the power supply 2. The power supply 2 may include an electric power supply in the form of a battery and/or an electrical connection to an external power source. The apparatus 1 includes a precursor 6, which in use is aerosolised by the aerosol generating unit 4 to generate an aerosol. The apparatus 2 includes a delivery system 8 for delivery of the aerosol to a user.

Electrical circuitry (not shown in FIG. 1) may be implemented to control the interoperability of the power supply 4 and aerosol generating unit 6.

In variant examples, which are not illustrated, the power supply 2 may be omitted since, e.g. an aerosol generating unit implemented as an atomiser with flow expansion may not require a power supply.

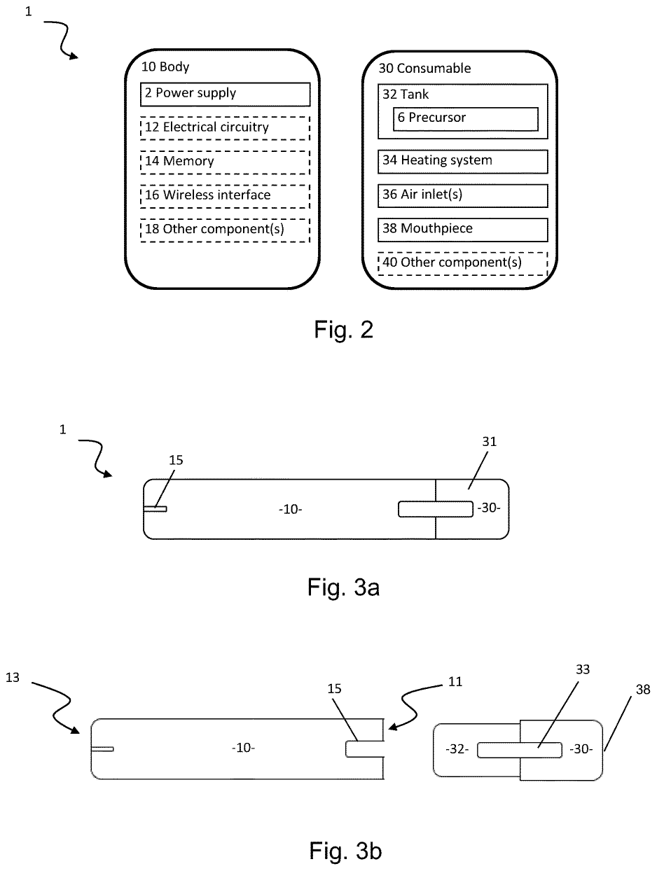

FIG. 2 shows an implementation of the apparatus 1 of FIG. 1, where the aerosol generating apparatus 1 is configured to generate aerosol from a liquid precursor.

In this example, the apparatus 1 includes a device body 10 and a consumable 30.

In this example, the body 10 includes the power supply 4. The body may additionally include any one or more of electrical circuitry 12, a memory 14, a wireless interface 16, one or more other components 18.

The electrical circuitry 12 may include a processing resource for controlling one or more operations of the body 10 and consumable 30, e.g. based on instructions stored in the memory 14.

The wireless interface 16 may be configured to communicate wirelessly with an external (e.g. mobile) device, e.g. via Bluetooth.

The other component(s) 18 may include one or more user interface devices configured to convey information to a user and/or a charging port, for example (see e.g. FIG. 3).

The consumable 30 includes a storage portion implemented here as a tank 32 which stores the liquid precursor 6 (e.g. e-liquid). The consumable 30 also includes a heating system 34, one or more air inlets 36, and a mouthpiece 38. The consumable 30 may include one or more other components 40.

The body 10 and consumable 30 may each include a respective electrical interface (not shown) to provide an electrical connection between one or more components of the body 10 with one or more components of the consumable 30. In this way, electrical power can be supplied to components (e.g. the heating system 34) of the consumable 30, without the consumable 30 needing to have its own power supply.

In use, a user may activate the aerosol generating apparatus 1 when inhaling through the mouthpiece 38, i.e. when performing a puff. The puff, performed by the user, may initiate a flow through a flow path in the consumable 30 which extends from the air inlet(s) 34 to the mouthpiece 38 via a region in proximity to the heating system 34.

Activation of the aerosol generating apparatus 1 may be initiated, for example, by an airflow sensor in the body 10 which detects airflow in the aerosol generating apparatus 1 (e.g. caused by a user inhaling through the mouthpiece), or by actuation of an actuator included in the body 10. Upon activation, the electrical circuitry 12 (e.g. under control of the processing resource) may supply electrical energy from the power supply 2 to the heating system 34 which may cause the heating system 32 to heat liquid precursor 6 drawn from the tank to produce an aerosol which is carried by the flow out of the mouthpiece 38.

In some examples, the heating system 34 may include a heating filament and a wick, wherein a first portion of the wick extends into the tank 32 in order to draw liquid precursor 6 out from the tank 32, wherein the heating filament coils around a second portion of the wick located outside the tank 32. The heating filament may be configured to heat up liquid precursor 6 drawn out of the tank 32 by the wick to produce the aerosol.

In this example, the aerosol generating unit 4 is provided by the above-described heating system 34 and the delivery system 8 is provided by the above-described flow path and mouthpiece 38.

In variant embodiments (not shown), any one or more of the precursor 6, heating system 34, air inlet(s) 36 and mouthpiece 38, may be included in the body 10. For example, the mouthpiece 36 may be included in the body 10 with the precursor 6 and heating system 32 arranged as a separable cartomizer.

FIGS. 3a and 3b show an example implementation of the aerosol generating device 1 of FIG. 2. In this example, the consumable 30 is implemented as a capsule/pod, which is shown in FIG. 3a as being physically coupled to the body 10, and is shown in FIG. 3b as being decoupled from the body 10.

In this example, the body 10 and the consumable 30 are configured to be physically coupled together by pushing the consumable 30 into an aperture in a top end 11 the body 10, with the consumable 30 being retained in the aperture via an interference fit.

In other examples (not shown), the body 10 and the consumable 30 could be physically coupled together in other ways, e.g. by screwing one onto the other, through a bayonet fitting, or through a snap engagement mechanism, for example.

The body 10 also includes a charging port (not shown) at a bottom end 13 of the body 10.

The body 10 also includes a user interface device configured to convey information to a user. Here, the user interface device is implemented as a light 15, which may e.g. be configured to illuminate when the apparatus 1 is activated. Other user interface devices are possible, e.g. to convey information haptically or audibly to a user.

In this example, the consumable 30 has an opaque cap 31, a translucent tank 32 and a translucent window 33. When the consumable 30 is physically coupled to the body 10 as shown in FIG. 3a, only the cap 31 and window 33 can be seen, with the tank 32 being obscured from view by the body 10. The body 10 includes a slot 15 to accommodate the window 33. The window 33 is configured to allow the amount of liquid precursor 6 in the tank 32 to be visually assessed, even when the consumable 30 is physically coupled to the body 10.

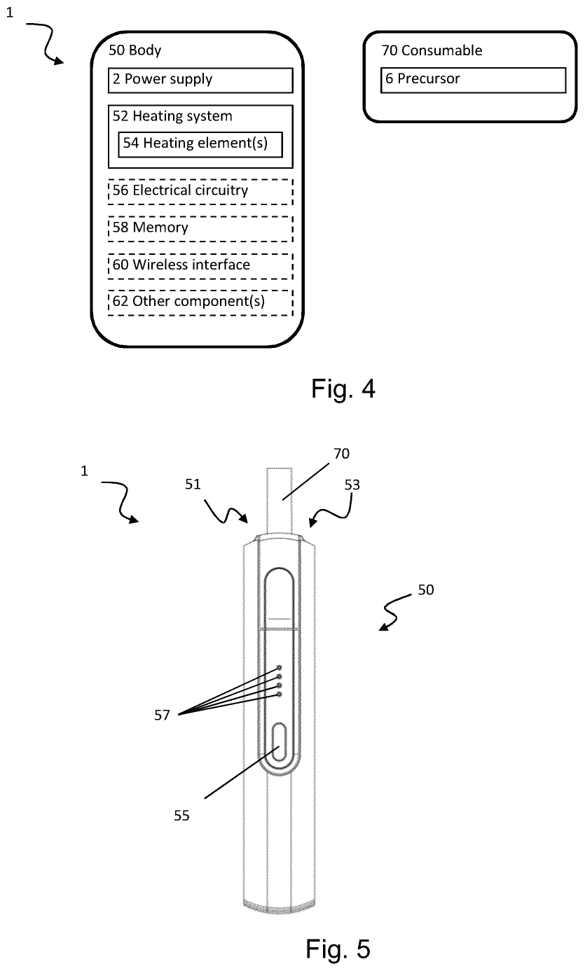

FIG. 4 shows an implementation of the apparatus 1 of FIG. 1, where the aerosol generating apparatus 1 is configured to generate aerosol by a-heat not-burn process.

In this example, the apparatus 1 includes a device body 50 and a consumable 70.

In this example, the body 50 includes the power supply 4 and a heating system 52. The heating system 54 includes at least one heating element 54. The body may additionally include any one or more of electrical circuitry 56, a memory 58, a wireless interface 60, one or more other components 62.

The electrical circuitry 56 may include a processing resource for controlling one or more operations of the body 50, e.g. based on instructions stored in the memory 58.

The wireless interface 60 may be configured to communicate wirelessly with an external (e.g. mobile) device, e.g. via Bluetooth.

The other component(s) 62 may include an actuator, one or more user interface devices configured to convey information to a user and/or a charging port, for example (see e.g. FIG. 5).

The body 50 is configured to engage with the consumable 70 such that the at least one heating element 54 of the heating system 52 penetrates into the solid precursor 6 of the consumable. In use, a user may activate the aerosol generating apparatus 1 to cause the heating system 52 of the body 50 to cause the at least one heating element 54 to heat the solid precursor 6 of the consumable (without combusting it) by conductive heat transfer, to generate an aerosol which is inhaled by the user.

FIG. 5 shows an example implementation of the aerosol generating device 1 of FIG. 2.

As depicted in FIG. 5, the consumable 70 is implemented as a stick, which is engaged with the body 50 by inserting the stick into an aperture at a top end 53 of the body 50, which causes the at least one heating element 54 of the heating system 52 to penetrate into the solid precursor 6.

The consumable 70 includes the solid precursor 6 proximal to the body 50, and a filter distal to the body 50. The filter serves as the mouthpiece of the consumable 70 and thus the apparatus 1 as a whole. The solid precursor 6 may be a reconstituted tobacco formulation.

In this example, the at least one heating element 54 is a rod-shaped element with a circular transverse profile. Other heating element shapes are possible, e.g. the at least one heating element may be blade-shaped (with a rectangular transverse profile) or tube-shaped (e.g. with a hollow transverse profile).

In this example, the body 50 includes a cap 51. In use the cap 51 is engaged at a top end 53 of the body 50. Although not apparent from FIG. 5, the cap 51 is moveable relative to the body 50. In particular, the cap 51 is slidable and can slide along a longitudinal axis of the body 50.

The body 50 also includes an actuator 55 on an outer surface of the body 50. In this example, the actuator 55 has the form of a button.

The body 50 also includes a user interface device configured to convey information to a user. Here, the user interface device is implemented as a plurality of lights 57, which may e.g. be configured to illuminate when the apparatus 1 is activated and/or to indicate a charging state of the power supply 4. Other user interface devices are possible, e.g. to convey information haptically or audibly to a user.

The body may also include an airflow sensor which detects airflow in the aerosol generating apparatus 1 (e.g. caused by a user inhaling through the consumable 70). This may be used to count puffs, for example.

In this example, the consumable 70 includes a flow path which transmits aerosol generated by the at least one heating element 54 to the mouthpiece of the consumable.

In this example, the aerosol generating unit 4 is provided by the above-described heating system 52 and the delivery system 8 is provided by the above-described flow path and mouthpiece of the consumable 70.

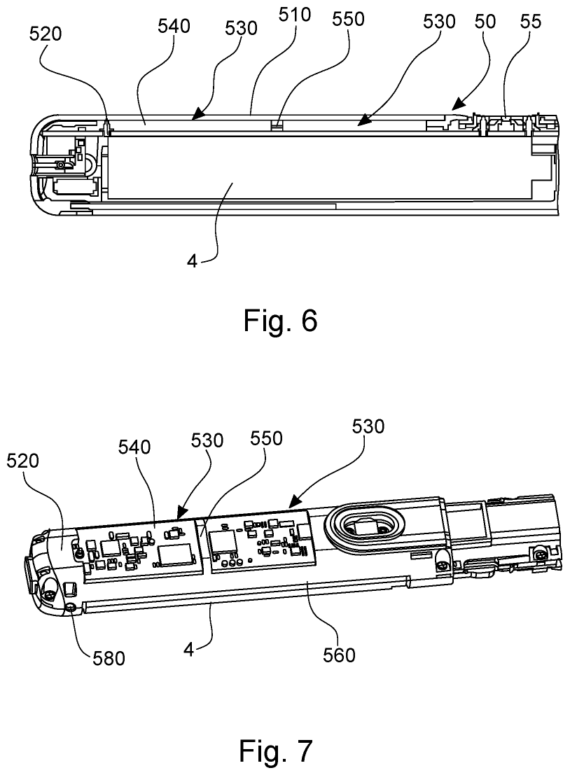

FIG. 6 shows an example implementation of the aerosol generating device 1 of FIG. 5. The aerosol generating device 1 includes a body 50 having an external housing 510 and an internal frame 520. The internal frame defines a space or chamber for the power source 4. The internal frame 520 further includes a window 530. The external housing 510 and window 530 define a cavity for receiving a portion of a PCB 540. In the illustrated example, the internal frame includes two windows 530 separated by a separation rib 550.

FIG. 7 illustrates the same implementation as FIG. 6, with the external housing 510 removed. This illustrates the window 530 and the location of the PCB 540. The separation rib 550 spans between two sides or struts 560 of the internal frame and across a portion of the PCB 540. In this example, a portion of the PCB 540 is therefore housed within a cavity defined by each of the two windows 530. The PCB 540 includes a substrate and a plurality of various electronic components 544 mounted on the substrate. The PCB 540 may thus include the electrical circuitry 56 and/or memory 58. The internal frame 520 further includes a socket 580 for receiving a fixing component (not illustrated) to fix the external housing 510 to the internal frame 520.

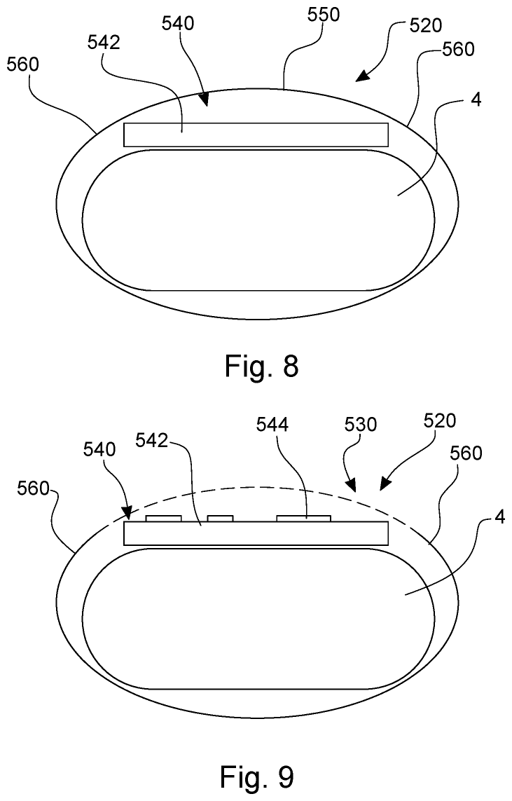

The internal frame 520 has an arcuate external profile. In other words, a boundary of volume occupied by the internal frame 520 has a convex curved shape. In this way, the internal frame 520 forms a space to be occupied by the PCB 540. This is illustrated exemplarily in FIG. 8 and FIG. 9. FIG. 8 shows a cross-section through the internal frame 520 at the separation rib 550 (i.e. a transverse plane about the longitudinal axis of the aerosol generating device). FIG. 9 shows a cross-section through the internal frame 520 at the window 530. As illustrated in FIG. 8, the struts 560 and separation rib 550 form an arcuate boundary of the internal frame 520. As illustrated in FIG. 9, the external profile of the internal frame 520 (as illustrated by the dashed line) remains arcuate even within the window 530.

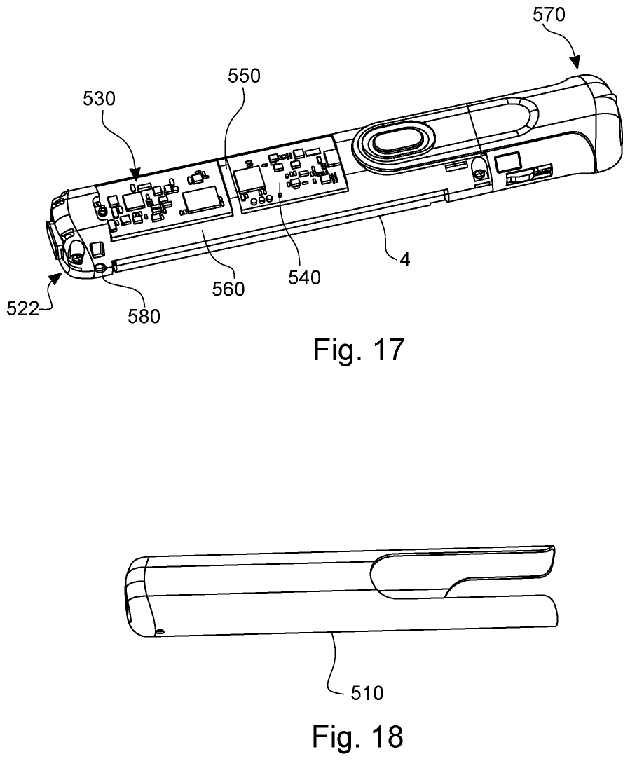

The external housing 510 has a corresponding arcuate internal profile. Therefore, the external housing 510 fits closely over and around the internal frame 520. In an embodiment, the internal frame 520 has a substantially constant external profile for a part of its length, enabling the external housing 510 to be slid over the internal frame 520 to assemble the aerosol generating device 1, as discussed further below with reference to FIG. 17 and FIG. 18.

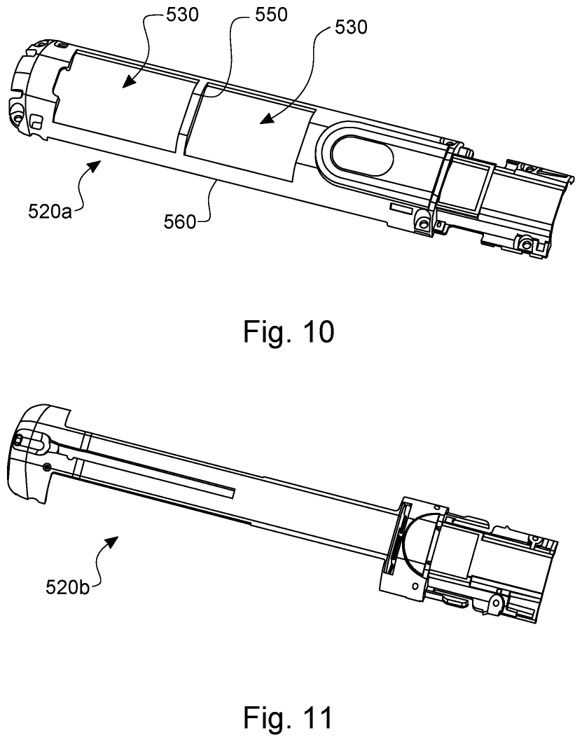

The internal frame 520 may be formed in multiple parts, such as a front portion 520a and a rear portion 520b. FIG. 10 illustrates a front portion 520a of the internal frame 520, indicating the windows 530 and the separation rib 550. In this example, therefore, the windows 530 are entirely formed within the front portion 520a of the internal frame 520. FIG. 11 illustrates a rear portion 520b of the internal frame 520. In this description of the internal frame portions 520a, 520b, the front refers to the side of the aerosol generating device 1 that would normally face a user while the device is in use, for example, the side of the device on which a user interface, e.g. a button is provided. The rear refers to the side of the aerosol generating device 1 that would normally face away from a user while the device is in use. In this embodiment, the front portion 520a of the internal frame 520 and the rear portion 520b of the internal frame 520 are joined together to form the internal frame 520. The front 520a and rear 520b internal frame portions can be joined at an interface where the two frame portions 520a, 520b are in mutual contact. In forming front and rear portions of the internal frame 520, the front 520a and rear 520b internal frame portions each form part of the external profile of the internal frame 520 in a transverse plane perpendicular to the longitudinal axis.

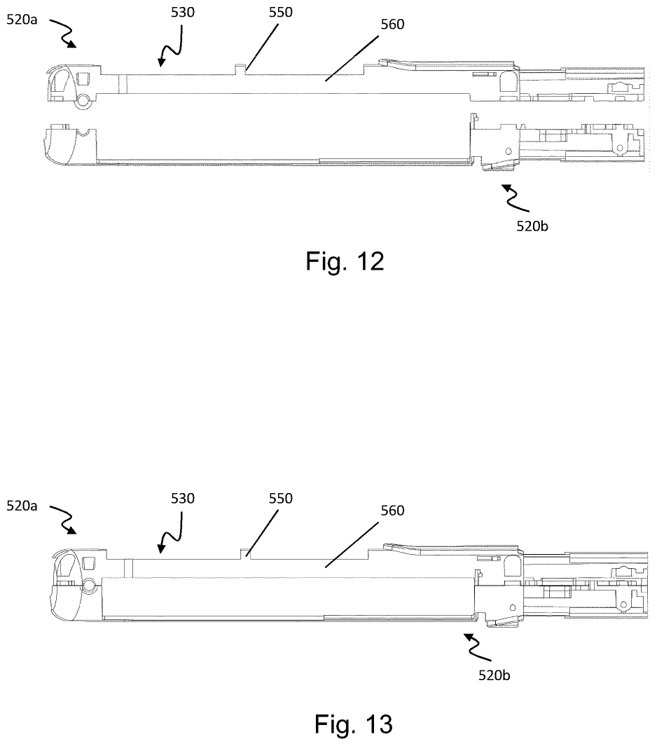

FIGS. 12 and 13 illustrate a side-on view of the two frame components 520a, 520b, showing this relative arrangement of the two parts before joining (FIG. 12) and after joining (FIG. 13). Other arrangements of the frame 520 are also possible, including arrangements where the frame is formed as a single component, or where the two portions of the frame are arranged differently (to form left and right-side portions, or top and bottom portions, for example).

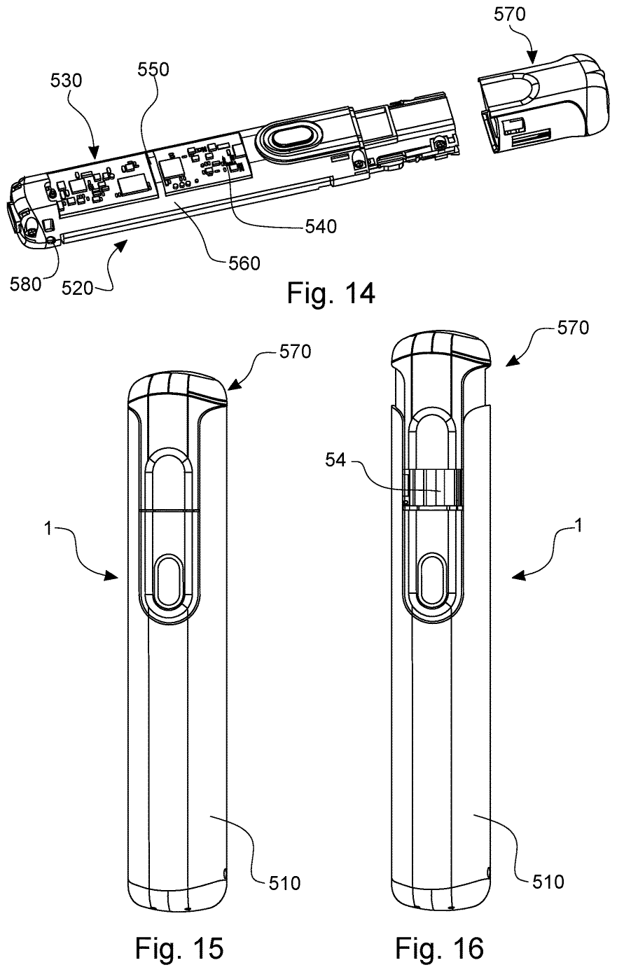

The aerosol generating device further comprises a cap 570, which is slidably mounted to the internal frame 520. The mounting of the cap to the internal frame is illustrated in FIG. 14. The internal frame 520 thus provides a support structure or chassis for the cap 570. FIGS. 15 and 16 illustrate the sliding motion of the cap between a first position (FIG. 15) where the heating element 54 is enclosed within the cap 570 and a second position (FIG. 16) where the heating element 54 is at least partially exposed in a gap between the cap 570 and the main body of the device 1.

FIG. 17 and FIG. 18 illustrate an internal frame assembly 522 which may be mounted in the external housing 510 to form the aerosol generating device. The internal frame assembly 522 includes an internal frame 520, a power source 4, a PCB 540, and a cap 570.

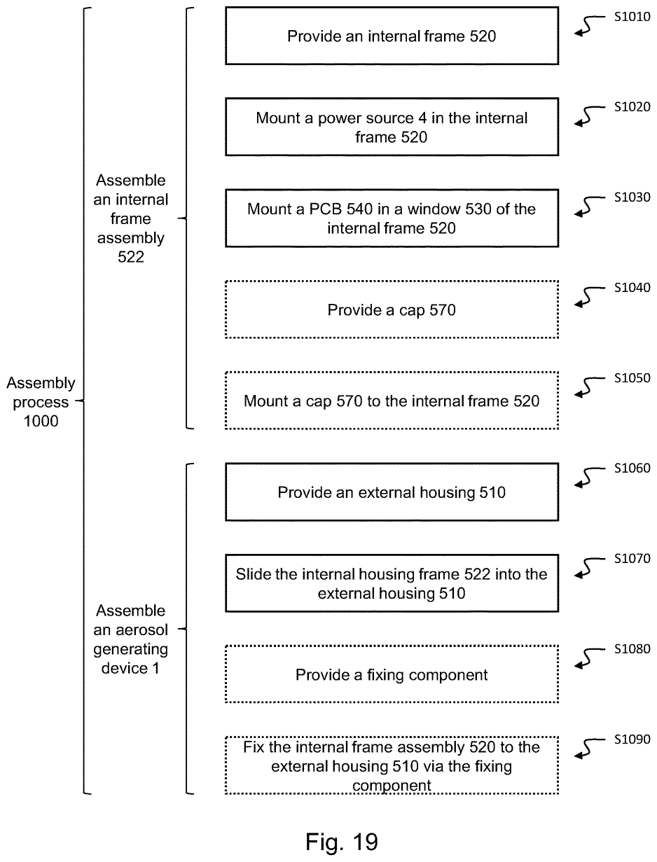

FIG. 19 sets out a process for assembling an aerosol generating device. The process 1000 involves the steps of producing an internal frame assembly 522 by providing (S1010) an internal frame 520; mounting (S1020) a power source 4 in the chamber; and mounting (S1030) a PCB 540 in the window 530, and, optionally, mounting (S1050) a cap 570 to the internal frame 520. The process 1000 further involves the steps of providing (S1060) an external housing 510; and sliding (S1070) the internal frame assembly 522 into the external housing 510. The process may optionally further include the step of providing (S1080) a fixing component (not illustrated) and fixing (S1090) the internal frame 520 to the external housing 510 via the fixing component.

1. An aerosol generating device, the aerosol generating device being elongate and having a longitudinal axis and a transverse axis perpendicular to the longitudinal axis, wherein the aerosol generating device comprises:
an external housing;
an internal frame defining a chamber for receiving a power source of the aerosol generating device, the internal frame being located within the external housing; and
a printed circuit board, “PCB”; wherein
the internal frame includes a window, the external housing and the window defining a PCB cavity for receiving a portion of the PCB.

2. An aerosol generating device according to claim 1, wherein:
the PCB comprises a substrate and an electronic component for controlling an operation of the aerosol generating device, the electronic component being mounted on a surface of the substrate.

3. An aerosol generating device according to claim 1, wherein the internal frame has an arcuate external profile in a transverse plane perpendicular to the longitudinal axis.

4. An aerosol generating device according to claim 3, wherein the external housing has an internal profile in the transverse plane commensurate with the external profile of the internal frame in the transverse plane.

5. An aerosol generating device according to claim 4, wherein the external profile of the internal frame is substantially constant along at least part of an extent of the internal frame along the longitudinal axis of the aerosol generating device.

6. An aerosol generating device according to claim 1, wherein the internal frame comprises a plurality of windows and at least one separation rib located between adjacent windows.

7. An aerosol generating device according to claim 6, wherein the internal frame comprises two longitudinally extending struts, and wherein the separation rib spans between the two struts.

8. An aerosol generating device according to claim 7, wherein:
the external housing and a first window of the plurality of windows define a first PCB cavity;
the external housing and a second window of the plurality of windows define a second PCB cavity; and wherein
a first portion of the PCB is received in the first PCB cavity and a second portion of the PCB is received in the second PCB cavity.

9. An aerosol generating device according to claim 1, wherein the internal frame includes a first internal frame component and a second internal frame component.

10. An aerosol generating device according to claim 9, wherein the first internal frame component and the second internal frame component are elongate along the longitudinal axis, and wherein
the first internal frame component defines a first part of the external profile of the internal frame in a transverse plane perpendicular to the longitudinal axis; and
the second internal frame component defines a second part of the external profile of the internal frame in the transverse plane perpendicular to the longitudinal axis.

11. An aerosol generating device according to claim 1, wherein the external housing is fixed to the internal frame via a fixing component.

12. An aerosol generating device according to claim 1, including:
a cap for engaging with a consumable for the aerosol generating device, wherein
the cap is slidably mounted to the internal frame to be slidable along a longitudinal axis of the aerosol generating device.

13. An aerosol generating device according to claim 12, including:
a heating element mounted to the internal frame, wherein
the cap is slidable between a first position wherein the heating element is enclosed within the cap and a second position wherein the heating element is at least partially exposed in a gap between the cap and housing.

14. An internal frame for use in an aerosol generating device according to claim 1.

15. A method of manufacturing an aerosol generating device according to claim 1, comprising the steps of:
providing an internal frame according to claim 14;
mounting a power source in the chamber
mounting a PCB in the window;
providing an external housing; and
sliding the internal frame into the external housing.

16. An aerosol generating device according to claim 1, wherein a portion of the PCB is received in the PCB cavity
